(19) United States
(12) Patent Application Publication
(10) Pub. No.: US 2024/0208424 A1
(43) Pub. Date: Jun. 27, 2024

(54) Replaceable Holder System

(71) Applicant: Caterpiller Inc., Peoria, IL (US)

(72) Inventors: Ashley Dallas MENGES, Clayton, NC (US); Ryan Patrick PICINOVSKY, Cedar Falls, IA (US); John E. MYSLIK, Hendersonville, NC (US); Jonathan Eugene STURM, Lagrange, IN (US); William C. MARTIN, Stillwater, OK (US)

(73) Assignee: Caterpiller Inc., Peoria, IL (US)

(21) Appl. No.: 18/569,106

(22) PCT Filed: Sep. 14, 2022
(86) PCT No.: PCT/US2022/043400

§ 371 Date: Dec. 11, 2023

Related U.S. Application Data
(60) Provisional application No. 63/245,381, filed on Sep. 17, 2021.

(51) Int. Cl. B60R 7/04; B60R 11/00; B60R 11/06

(52) U.S. Cl. CPC B60R 7/04; B60R 2011/0075; B60R 11/06

(57) ABSTRACT

Replaceable holder system, including a mount with a ramp formed at a rear portion and with a bottom portion, a removable holder with a receptacle at one side of a back plate including a projection extending from an opposite side of said back plate, and a cantilever extending from the opposite side of said back plate, the cantilever having a securement projection catch, the securement projection catch being located at a distal portion of the cantilever. When the removable holder is mounted in the work machine operator cab, the projection of the removable holder engages the ramp of the mount, and the securement projection catch engages the bottom portion of the mount.

### TECHNICAL FIELD

The present disclosure relates to a system for replaceably securing a holder to the interior of a work machine.

### BACKGROUND

Compact loaders, such as skid steer loaders or compact track loaders, are relatively small work machines that can provide a variety of lifting and moving functions in tight spaces. Well balanced and highly maneuverable, compact loaders often are used in rugged outdoor environments, such as with heavy construction or mining. A compact loader typically has an operator cab centered or somewhat forward on a frame, lift arms that pivot on left and right sides of the frame, and a work tool such as a shovel manipulated by the lift arms. Wheels or tracks that may be separately driven, combined with the relatively small size of the loader, contribute to the high maneuverability of the machine. An internal combustion engine mounted in a compartment behind the operator cab powers the loader and provides a counterbalance to a load on the work tool in front.

Owing to their small size, the operator cab of a compact loader typically has limited space for the operator to store personal belongings such as a beverage container, mobile phone, calculator, documents, work tools, or other small items. Since different operators may have different storage needs, it would be useful to provide an operator cab which the operator could customize to meet their specific storage needs.

An example of such a skid steer loader can be found in U.S. Patent App. Pub. No. 2016/0053459A1.

### SUMMARY

In one aspect of the present disclosure, a system for mounting a removable holder in an interior of a work machine operator cab can include an interior panel having a panel face configured to be exposed when the interior panel is mounted within the work machine operator cab, a first recess having a first recess face, at least a portion of the first recess face being located further from the interior of the work machine operator cab than the panel face when the interior panel is mounted within the work machine operator cab, a second recess having a second recess face; at least a portion of the second recess face being located further from the interior of the work machine operator cab than the portion of the first recess face when the interior panel is mounted within the work machine operator cab, a mount having a rear portion, a bottom portion, and a ramp formed in the rear face, the mount being disposed within the second recess, and an access relief located below the bottom portion of the mount and configured to permit manual access. The system can also include a removable holder with a back plate having a front portion and a rear portion, a sidewall, the sidewall and the front portion of the back plate together defining a receptacle, a projection extending outward from the rear portion of the back plate, and a cantilever extending from the rear portion of the back plate, the cantilever having a securement projection and a finger catch, the securement projection and finger catch being located at a distal portion of the cantilever. When the removable holder is mounted in the work machine operator cab, the projection of the removable holder can engage the ramp of the mount, and the securement projection of the cantilever can engage the bottom portion of the mount.

In another aspect of the present disclosure, a removable holder for mounting in an interior of a work machine operator cab having a mount having a rear portion, a bottom portion, and a ramp formed in the rear portion, can include a back plate having a front portion and a rear portion, a sidewall, the sidewall and the front portion of the back plate together defining a receptacle, a projection extending outward from the rear portion of the back plate, and a cantilever extending from the rear portion of the back plate, the cantilever having a securement projection and a finger catch, the securement projection and finger catch being located at a distal portion of the cantilever. When the removable holder is mounted in the work machine operator cab, the projection can engage the ramp of the mount, and the securement projection of the cantilever can engage the bottom portion of the mount.

Other features and aspects of this disclosure will be apparent from the following description and the accompanying drawings.

### BRIEF DESCRIPTION OF THE DRAWINGS

FIG. 1A is a front perspective view of a portion of a cabin panel having an attachment structure for mounting holders, and FIG. 1B is a side cross-sectional view along line 1B-1B of FIG. 1A, according to examples of the present disclosure;

FIGS. 2A and 2B are, respectively, perspective views of a cupholder and mobile phone holder, according to examples of the present disclosure, and FIG. 2C is a side cross-sectional view through plane 2C-2C of FIG. 2A;

FIGS. 3A and 3B are, respectively, partially-transparent perspective views of the cupholder and mobile phone holder of FIGS. 2A and 2B, according to examples of the present disclosure;

FIGS. 4A and 4B are, respectively, front elevational views of the cupholder and mobile phone holder, according to examples of the present disclosure;

FIGS. 5A and 5B are, respectively, partially-transparent front elevational views of the cupholder and mobile phone holder of FIGS. 4A and 4B, according to examples of the present disclosure;

FIGS. 6A and 6B are, respectively, side elevational views of a cupholder and mobile phone holder, according to examples of the present disclosure;

FIGS. 7A and 7B are, respectively, partially-transparent side elevational views of the cupholder and mobile phone holder of FIGS. 6A and 6B, according to examples of the present disclosure;

FIGS. 8A and 8B are, respectively, rear elevational views of a cupholder and mobile phone holder, according to examples of the present disclosure;

FIGS. 9A and 9B are, respectively, top plan views of a cupholder and mobile phone holder, according to examples of the present disclosure;

FIGS. 10A and 10B are, respectively, partially-transparent top plan views of the cupholder and mobile phone holder of FIGS. 9A and 9B and which have both been rotated 180 degrees from the orientations shown in FIGS. 9A and 9B, according to examples of the present disclosure.

FIGS. 11A and 11B are, respectively, bottom plan views of a cupholder and mobile phone holder, according to examples of the present disclosure;

FIGS. 12A and 12B are, respectively, are partially-transparent bottom plan views of the cupholder and mobile phone holder of FIGS. 9A and 9B;

FIGS. 13A and 13B are, respectively, bottom perspective views of a cupholder and mobile phone holder, according to examples of the present disclosure;

FIGS. 14A and 14B are, respectively, bottom perspective views of a cupholder and mobile phone holder, according to examples of the present disclosure;

FIGS. 15A and 15B are, respectively, partially-transparent top plan views of the cupholder and mobile phone holder of FIGS. 13A and 13B;

FIGS. 16A and 16B are, respectively, partially-transparent top plan views of the cupholder and mobile phone holder of FIGS. 14A and 14B;

FIGS. 17A and 17B are, respectively, top perspective views of a cupholder and mobile phone holder, according to examples of the present disclosure;

FIGS. 18A and 18B are, respectively, top perspective views of a cupholder and mobile phone holder, according to examples of the present disclosure;

FIGS. 19A and 19B are, respectively, partially-transparent top perspective views of the cupholder and mobile phone holder of FIGS. 17A and 17B; and

FIGS. 20A and 20B are, respectively, partially-transparent top perspective views of the cupholder and mobile phone holder of FIGS. 18A and 18B.

### DETAILED DESCRIPTION

Wherever possible, the same reference numbers will be used throughout the drawings to refer to the same or the like parts. Wherever possible, corresponding or similar reference numbers will be used throughout the drawings to refer to the same or corresponding parts.

In the interests of conciseness, reference numbers have not been appended to all drawings. Applicant reserves the right, for any subsequent application(s), to add to various drawing sheets reference numbers corresponding to those presently included in the drawings to identify the same structure that has been designated with reference numbers in other accompanying drawings. Applicant also reserves the right to claim and/or disclaim any portions.

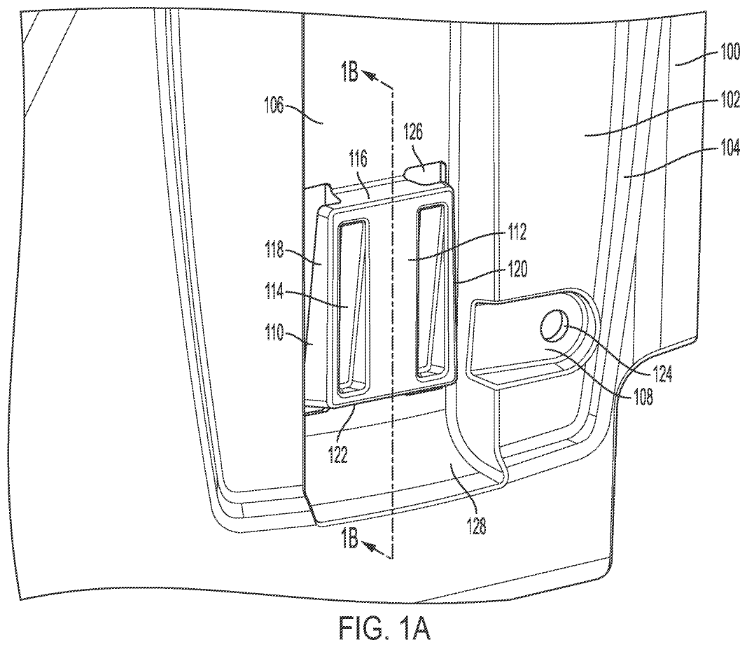

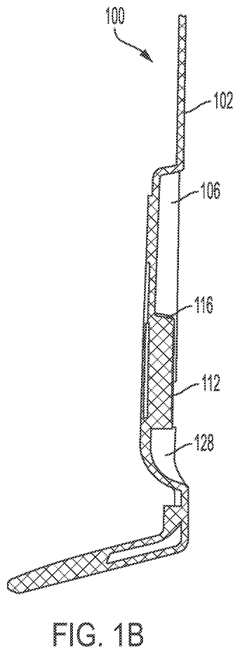

FIG. 1A depicts a panel 100 that can have a main recessed region 102 with a main recess perimeter 104. Panel 100 can be generally planar or can have a contour appropriate for the work machine in which panel 100 is to be installed. Main recess perimeter 104 can have a rounded profile, to avoid sharp edges. Holder recess 106 can be defined in the main recessed region 102, and may be centrally located. Panel 100 can also include an attachment recess 108, which can include a fastener opening 124. Panel 100 can be attached to the work machine by inserting a suitable fastener through fastener opening 124 into engagement with a corresponding portion of the work machine. If desired, a cover then can be affixed to the attachment recess 108 or fastener opening 124.

Securement structure 110 can be formed in holder recess 106, and can be an integral part of the panel 100. Alternatively, securement structure 110 can be formed separately and then be attached to panel 100, for example, using ultrasonic welding, adhesive, or a fastener. Further, it may be possible to modify an existing panel to accommodate a securement structure 110.

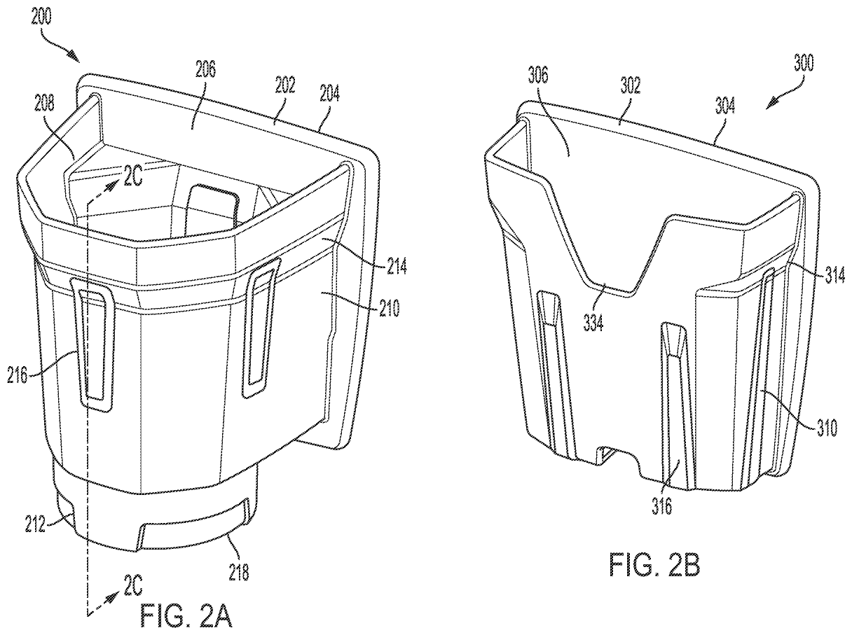

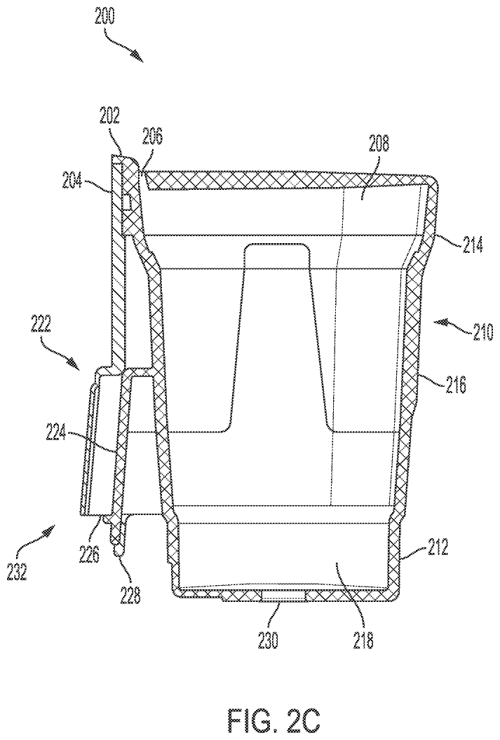

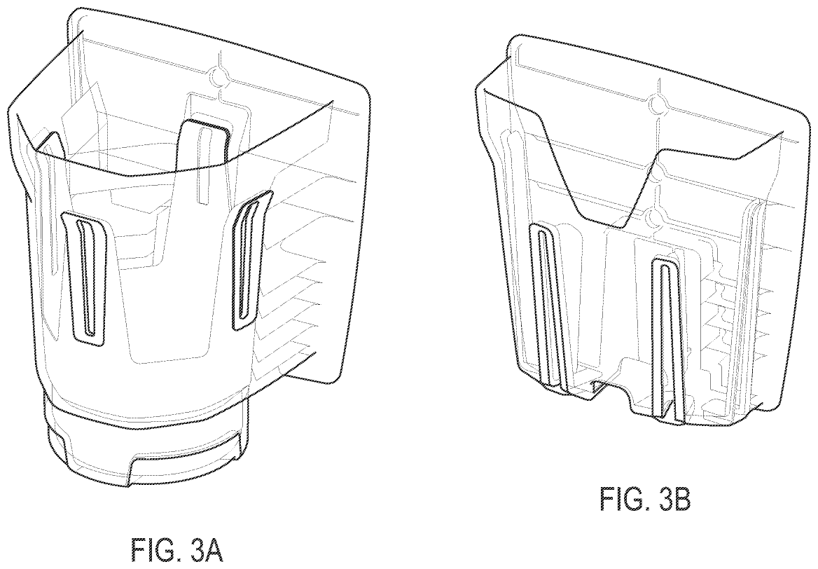

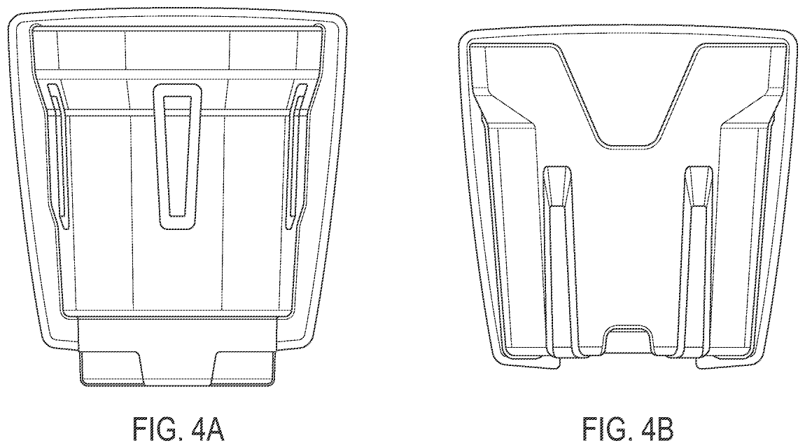

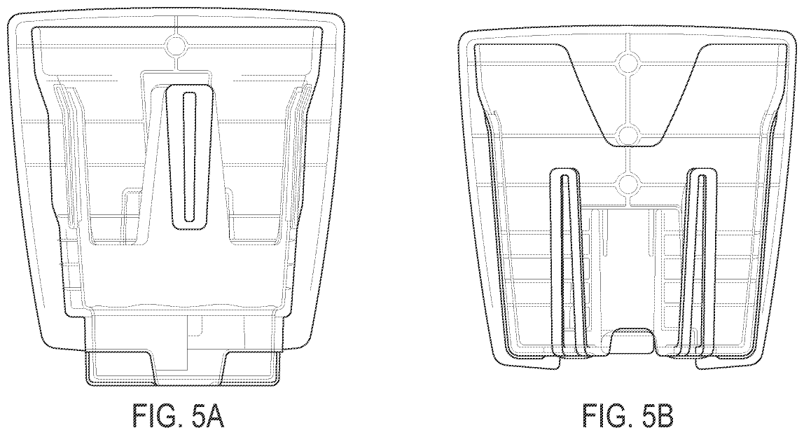

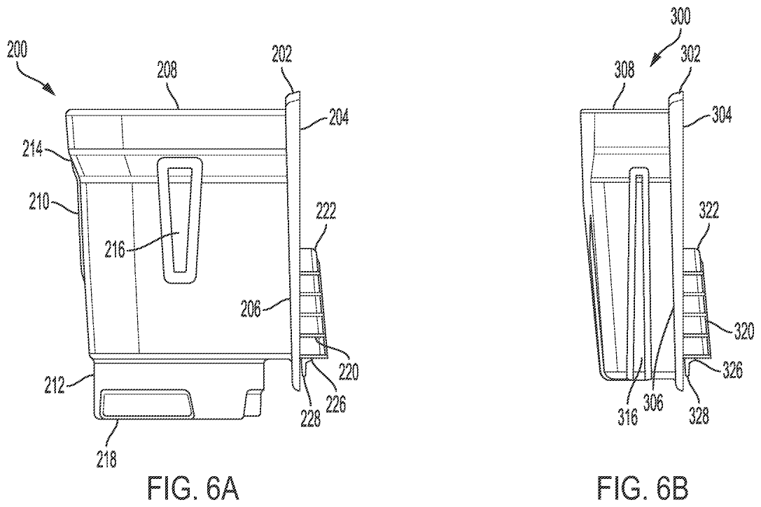

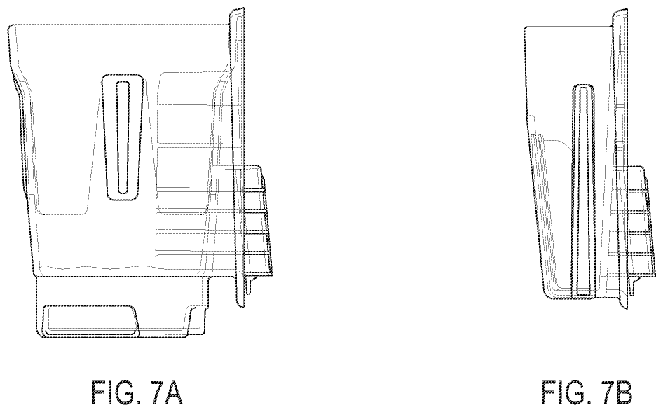

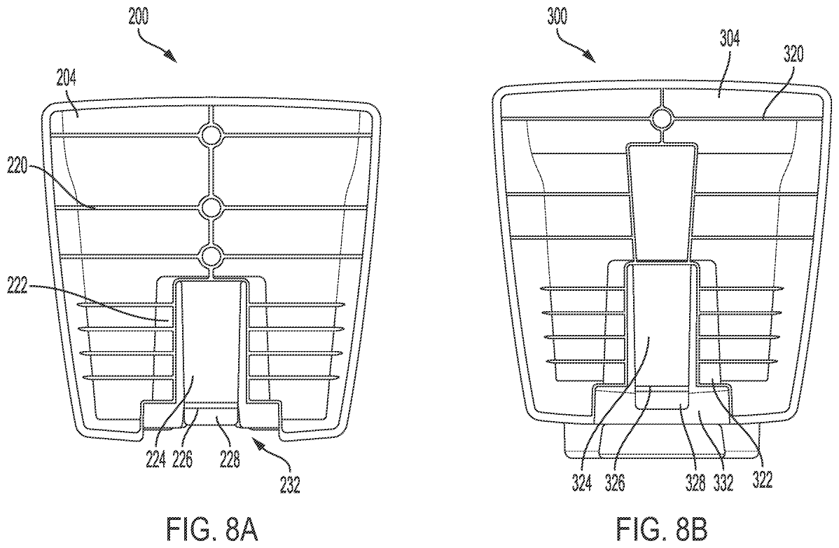

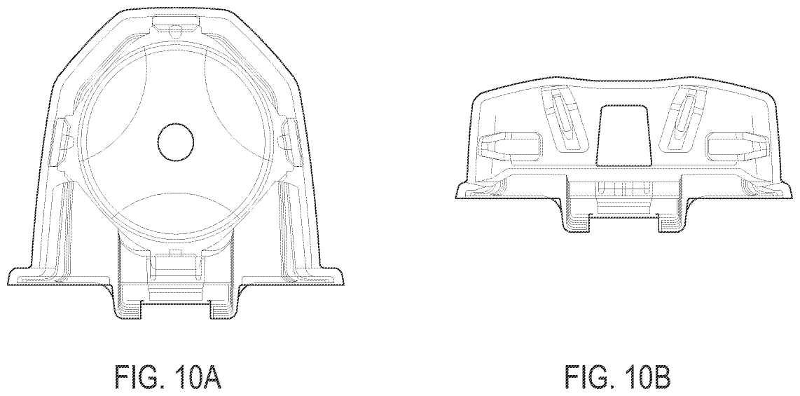

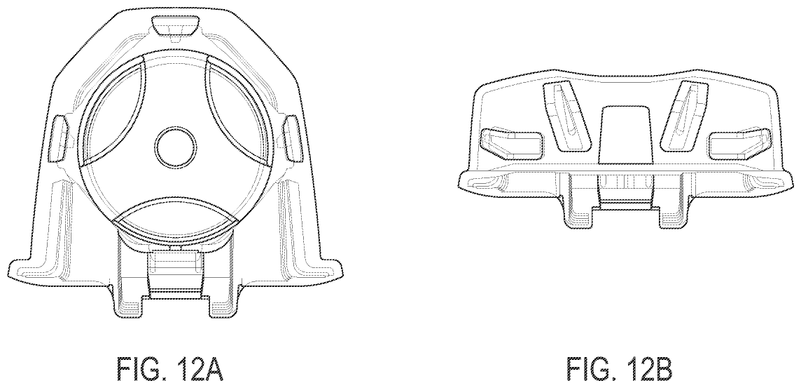

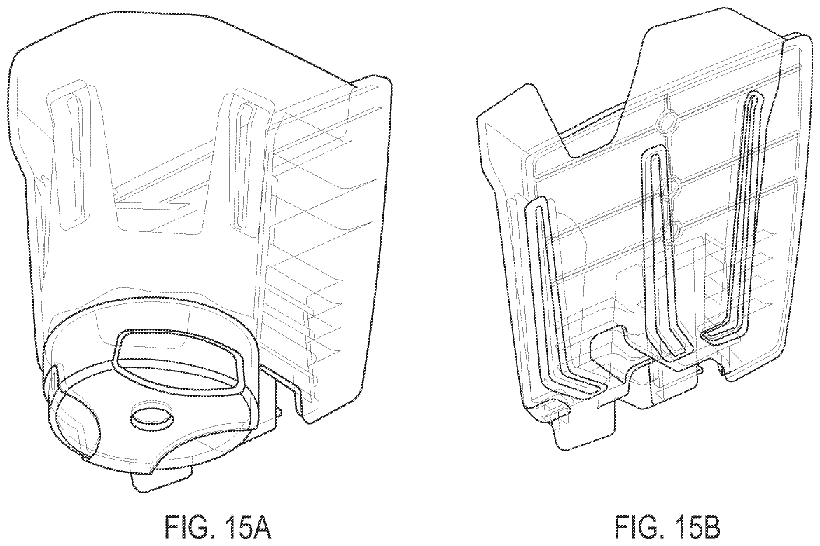

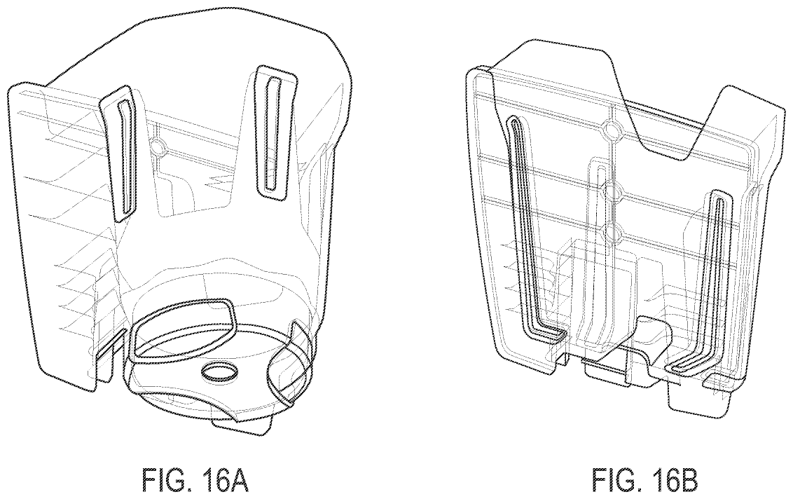

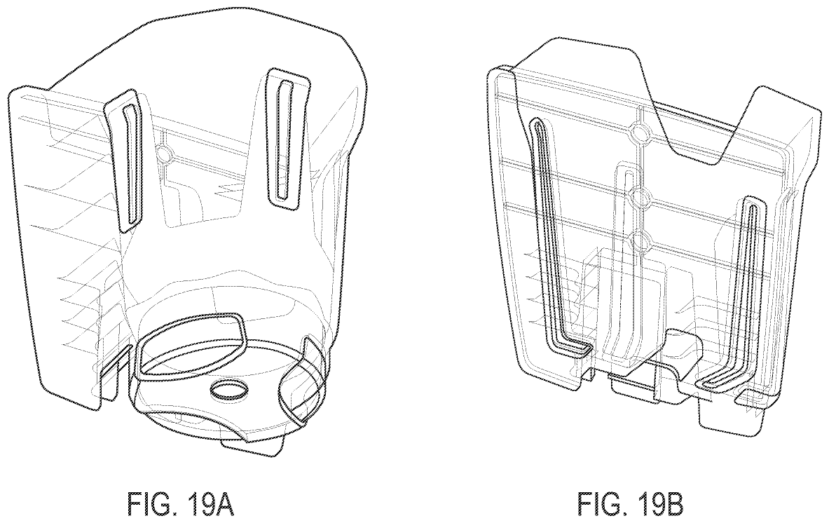

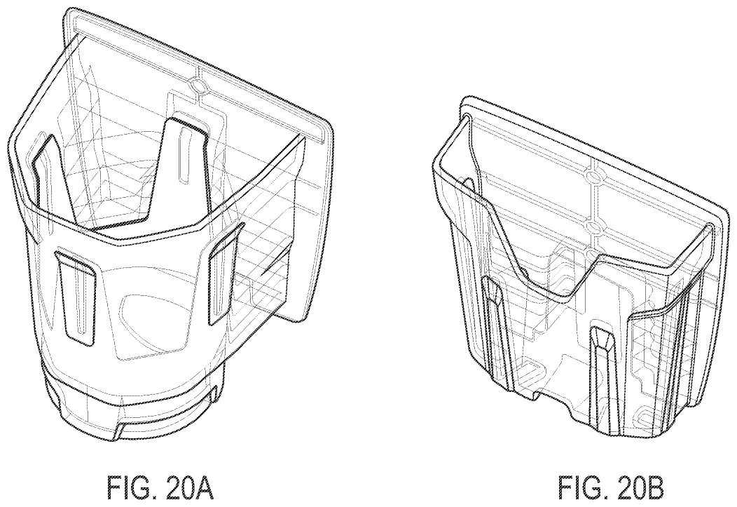

Securement structure 110 can be configured to engage corresponding structure of a replaceable holder, such as the cup holder 200 or mobile phone holder 300 depicted in FIGS. 2A-20B. Securement structure 110 may include front face 112, a top side 116, left side 118, right side 120, and a bottom side 122. Securement structure 110 can be generally rectangular when viewed from the front, and each of the front face 112, top side 116, left side 118, right side 120, and bottom side 122 can be generally planar. Portions where the face and sides meet can be rounded or chamfered. Securement structure 110 can be centrally located within panel 100 in the widthwise direction.

As depicted in FIG. 1A, at least one ramp 114 can be formed in the front face 112. As will be described hereafter, ramp 114 can cooperate with structure of the replaceable holder so that the replaceable holder is firmly held and cannot come loose during work machine operation.

Panel 100 can include at least one through slot 126 to accommodate portions of the replaceable holder, as described hereafter. As shown in FIG. 1A and FIG. 1B, the front face 112 of the securement structure 110 can be spaced forward of the surface of the holder recess 106 by the top side 116, and this spacing can facilitate access to the through slot 126.

Panel 100 can also include an access relief region 128 below the securement structure 110. The access relief region 128 can be contoured to allow an operator to use their finger (or a tool) to reach behind a mounted replaceable holder, such as cup holder 200 or mobile phone holder 300, which is held in place in part by a release structure on the replaceable holder, described hereafter, and operate that release structure so that the replaceable holder can be removed.

Panel 100 can be made from any suitable material, including polymers. Panel 100 can be formed using injection molding, three-dimensional printing, or any other suitable manufacturing technique.

An exemplary replaceable holder in the form of a cup holder 200, according to one or more embodiments of the present disclosure, is depicted in FIGS. 2A, 2C, 3A, 4A, 5A, 6A, 7A, 8A, 9A, 10A, 11A, 12A, 13A, 14A, 15A, 16A, 17A, 18A, 19A, and 20A. Cup holder 200 can include a back plate 202 having a rear side 204 and a front side 206. An upper sidewall 210, lower sidewall 212, and flared sidewall 214, together, can define a volume shaped to accommodate a cup or beverage container. The flared sidewall 214 can define a top opening 208 dimensioned to facilitate placement of the cup or beverage container in the volume. If desired, lower sidewall 212 can have a pocket 218 shaped to conform closely to a corresponding portion of the cup or beverage container, which can reduce the likelihood of the cup or beverage container coming loose from the cup holder 200 due to movement or vibration of the work machine.

Back plate 202, upper sidewall 210, lower sidewall 212, flared sidewall 214, and pocket 218 can be integrally formed, or can be assembled from separate parts which are then joined together.

Cup holder 200 can include one or more stiffening projections 216. As depicted, stiffening projection 216 can project outward from the surface of upper sidewall 210 and flared sidewall 214, but also could be shaped to extend inward from the inner surface of the upper sidewall 210 and/or flared sidewall 214, and, further, could be dimensioned to engage a portion of the cup or beverage container.

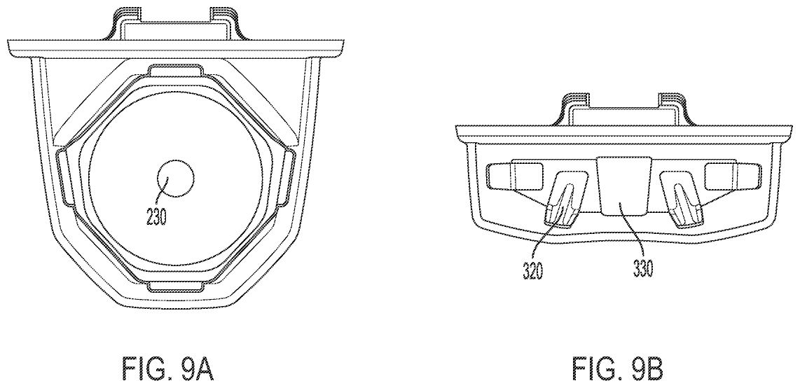

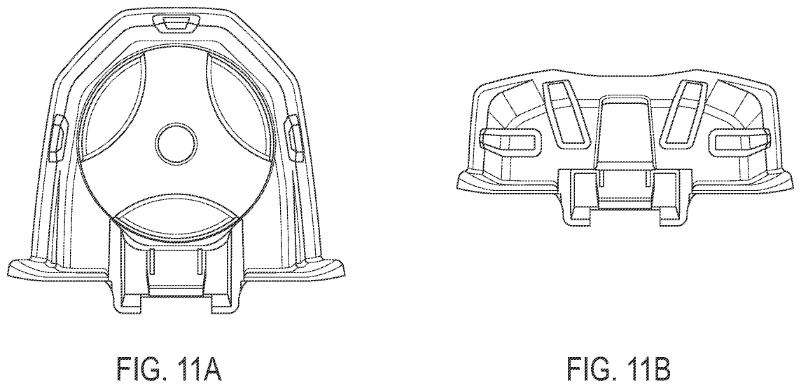

As depicted in FIG. 9A and FIG. 11A, for instance, cup holder 200 may include a drain opening 230 formed in pocket 218, so that any spilled liquid (or washing fluid, if the machine interior is liquid cleaned) can run out.

An exemplary manner in which cup holder 200 can be removably attached to panel 100 now will be described.

To join the cup holder 200 to panel 100, the cup holder 200 can be positioned so that the securement projection 222 and the catch 226 of cantilever 224 engage the corresponding portions of securement structure 110 of the panel 100. More specifically, cup holder 200 can be positioned in front of securement structure 110 in holder recess 106. Cup holder 200 can be lowered onto the securement structure 110 so that the top edge 116 of securement structure 110 enters mounting receptacle 232, with a portion of the securement projection 222 passing behind the ramp 114 of securement structure 110. Ramp 114 can be shaped so that, as cup holder 200 is lowered, the abutting securement portion 222 can be guided by sliding contact with the ramp 114 and the cup holder 200 can be pulled toward the panel 100. As the cup holder 200 moves downward, catch 226 can strike the edge of top side 116 and rides along front face 112. This can elastically displace the attached cantilever 224, which can apply force to the catch 226 that presses the catch 226 toward the front face 112. As the cup holder 200 reaches its final position, catch 226 can pass beyond bottom side 122 of the securement structure 110, and the force applied by the cantilever 224 can cause the catch 226 to move beneath the bottom side 122 of the securement structure 110. This can provide positive engagement between the panel 100 and the cup holder 200 and can prevent the cup holder from coming loose due to work machine motion or vibration.

To disengage the cup holder 200 from panel 100, a user can position their finger tip (or a suitable tool) in the access relief 128 in the region beneath the beneath the tab 228 of cup holder 200. The user can then shift the tab forward (toward the user) against the elastic force of cantilever 224 so that the catch 226 no longer is positioned beneath the bottom side 122 of securement structure 110. The user then can lift the cup holder upward, release the tab (the catch 226 will ride along front face 112 of securement structure 110 during the upward movement), and separate the cup holder 200 from the panel 100.

A replaceable holder in the form of a mobile phone holder 300 is depicted in FIGS. 2B, 3B, 4B, 5B, 6B, 7B, 8B, 9B, 10B, 11B, 12B, 13B, 14B, 15B, 16B, 17B, 18B, 19B, and 20B. Features corresponding to those described above in connection with cup holder 200 are identified with the format 3XX, X being a number between 0 and 9. The foregoing discussion of the features of cup holder 200 is correspondingly applicable to these features of mobile phone holder 300 and, for the sake of conciseness, is incorporated herein.

Mobile phone holder 300 may include at least one internal rib 320 within its receptacle portion (see e.g., FIG. 9B) and configured to abut a mobile phone held therein. The rib 320 can raise the phone slightly so that, should any liquid accumulate at the bottom of the mobile phone holder 300 despite the presence of drain hole 330, the rib 320 raises the mobile phone above such liquid.

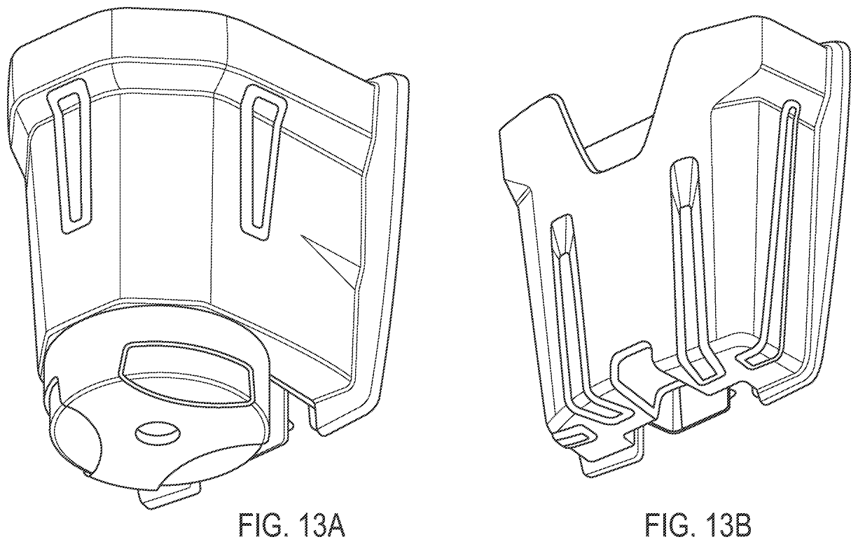

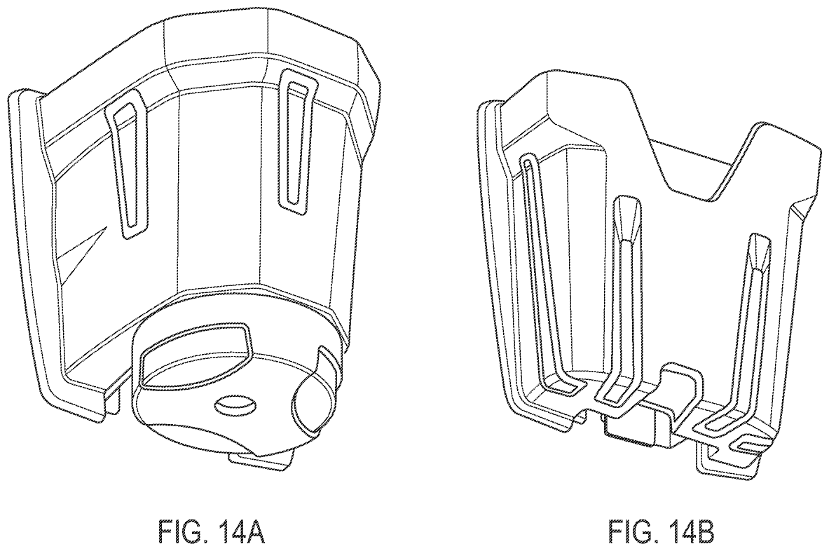

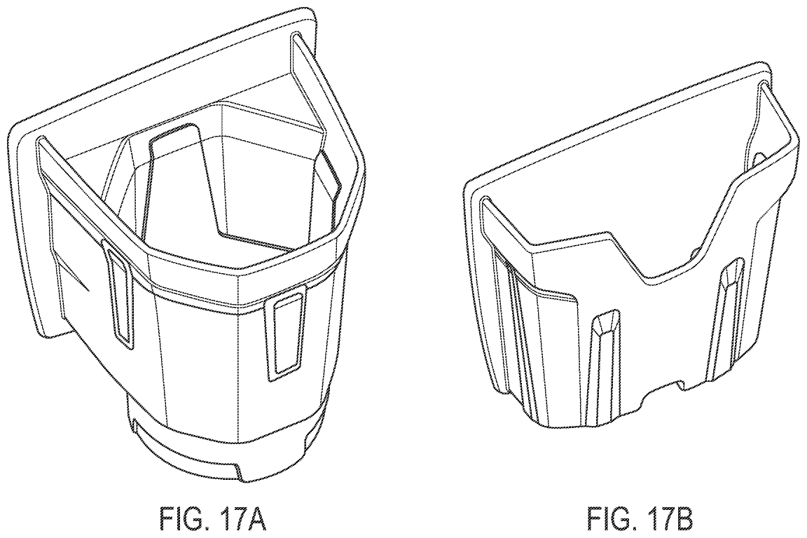

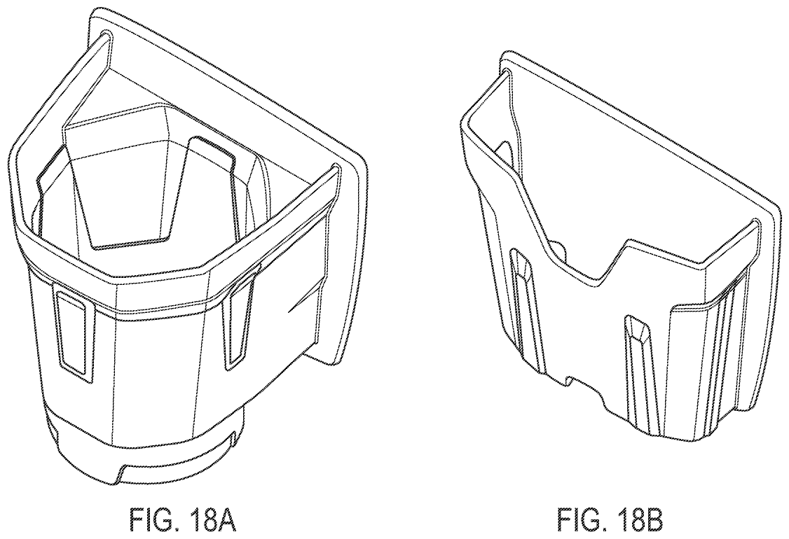

Mobile phone holder 300 also may include a generally V-shaped notch 334 (see e.g., FIG. 2B, FIG. 13B, FIG. 14B, FIG. 17B, FIG. 18B) to allow a user to more easily grasp a mobile phone held therein. Other suitable notch shapes can be employed, however.

Substantially the same or substantially the same procedures as described above in connection with the removable cup holder 200 can be employed to join mobile phone holder 300 to panel 100 and to separate phone holder 300 from panel 100.

Replaceable holders such as cup holder 200 and mobile phone holder 300 can be made from any suitable material, including polymers. Replaceable holders can be formed using injection molding, three-dimensional printing, or any other suitable manufacturing technique.

### INDUSTRIAL APPLICABILITY

The foregoing embodiments facilitate operator customization of the interior of a work machine, and allow for more efficient use of the limited space available in the operator cab. The mounting arrangement depicted also can be used to mount additional structural components of a work machine, such as a communications device, climate sensor, electronic appliance, and audio-video unit. In a further embodiment, the orientation of the mounting projection and mounting receptacle can be changed, for example, by rotating each 180 degrees from the configuration depicted in FIGS. 1A-20B; thus, the cup holder or mobile phone holder could be moved downward to engage the mounting projection, and the cantilever being accessible to users from above. In this embodiment the structure of the panel could be suitably modified to facilitate user access to the cantilever.

In yet a further embodiment, the location of the mounting projection and mounting receptacle can be reversed, such that the mounting projection is located on the rear surface of the back plate of the cup holder or mobile phone holder and the mounting receptacle is located on the panel.

The embodiments can be used with all types of object holders, cup and mobile phone holders are described by way of example only and not limitation. In the foregoing discuss of cup and mobile phone holders, any other suitable object holder could be substituted therefor.

Although the foregoing embodiments have been described in connection with a skid steer loader, those embodiments can be used in other work machines, such as motor graders, bulldozers, haul trucks, pipe layers, excavators and wheel loaders.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

1. A system for mounting a removable holder in an interior of a work machine operator cab, comprising:
an interior panel including:
a panel face configured to be exposed when the interior panel is mounted within the work machine operator cab;
a first recess having a first recess face, at least a portion of the first recess face being located further from the interior of the work machine operator cab than the panel face when the interior panel is mounted within the work machine operator cab; a second recess having a second recess face; at least a portion of the second recess face being located further from the interior of the work machine operator cab than the portion of the first recess face when the interior panel is mounted within the work machine operator cab;
a mount having a rear portion, a bottom portion, and a ramp formed in the rear portion, the mount being disposed within the second recess; and
an access relief located below the bottom portion of the mount and configured to permit manual access;
a removable holder, including:
a back plate having a front portion and a rear portion,
a sidewall, the sidewall and the front portion of the back plate together defining a receptacle;
a projection extending outward from the rear portion of the back plate, the projection configured to always cooperate with the ramp during mounting;
a cantilever extending from the rear portion of the back plate, the cantilever having a securement projection catch, the securement projection catch being located at a distal portion of the cantilever,
wherein, when the removable holder is mounted in the work machine operator cab, the projection of the removable holder engages the ramp of the mount such that the removable holder is pulled toward the interior panel, and the securement projection catch of the cantilever engages the bottom portion of the mount.

2. The system according to claim 1, wherein the sidewall includes a lower sidewall, an upper sidewall, and a flared sidewall, the lower sidewall, the upper sidewall, and the flared portion together defining an object holder.

3. The system according to claim 1, wherein the sidewall includes at least one stiffening projection.

4. The system according to claim 1, wherein the back plate includes a plurality of ribs.

5. The system according to claim 4, wherein the plurality of ribs are disposed on a rear side of the back plate.

6. The system according to claim 1, wherein the removable holder includes a drain opening.

7. The system according to claim 1, wherein at least one of the mount and removable holder comprise three-dimensionally printed material.

8. A removable holder for mounting in an interior of a work machine operator cab having an interior panel and a mount having a rear portion, a bottom portion, and a ramp formed in the rear portion, comprising:
a back plate having a front portion and a rear portion, a sidewall, the sidewall and the front portion of the back plate together defining a receptacle;
a projection extending outward from the rear portion of the back plate, the projection configured to always cooperate with the ramp during mounting;
a cantilever extending from the rear portion of the back plate, the cantilever having a securement projection catch, the securement projection catch being located at a distal portion of the cantilever,
wherein, when the removable holder is mounted in the work machine operator cab, the projection engages the ramp (114) of the mount (110) such that the removable holder is pulled toward the interior panel, and the securement projection catch (226, 326) engages the bottom portion (122) of the mount (110).

9. The removable holder according to claim 8, wherein the sidewall includes a lower sidewall, an upper sidewall, and a flared sidewall, the lower sidewall, the upper sidewall, and the flared portion together defining an object holder.

10. The removable holder according to claim 8, wherein the sidewall includes at least one stiffening projection.

11. The removable holder according to claim 8, wherein the back plate includes a plurality of ribs.

12. The removable holder according to claim 11, wherein the plurality of ribs are disposed on a rear side of the back plate.

13. The removable holder according to claim 8, wherein the removable holder includes a drain opening.

14. The removable holder according to claim 8, wherein the removable holder comprises three-dimensionally printed material.
